(19) United States
(12) Patent Application Publication
(10) Pub. No.: US 2016/0017751 A1
(43) Pub. Date: Jan. 21, 2016

(54) COOLING DEVICE FOR A TURBOJET ENGINE OF AN AIRCRAFT NACELLE

(71) Applicant: AIRCELLE, GONFREVILLE L'ORCHER (FR)

(72) Inventor: Pierre Caruel, Le Havre (FR)

(73) Assignee: AIRCELLE, GONFREVILLE L'ORCHER (FR)

(21) Appl. No.: 14/865,072

(22) Filed: Sep. 25, 2015

Related U.S. Application Data
(63) Continuation of application No. PCT/FR2014/050717, filed on Mar. 26, 2014.

(30) Foreign Application Priority Data
Mar. 26, 2013 (FR) 13/52703

(51) Int. Cl. F01D 25/12; F01D 25/02; F01D 25/24

(52) U.S. Cl. CPC F01D 25/12; F01D 25/24; F01D 25/02; F05D 2220/10; F05D 2260/213

(57) ABSTRACT

The present disclosure provides a cooling device for a turbo engine of an aircraft nacelle, including: a heat exchanger and an air outlet pipe. The nacelle includes a front housing that has a front lip forming a hollow leading edge that delimits an annular de-icing chamber. In particular, the cooling device further includes a pipe for supplying pressurized air that extends from an inlet end linked to a pressurized air source, to an outlet end forming an air ejection nozzle opening into the de-icing chamber, and the outlet pipe of the heat exchanger has an air outlet section that is arranged in the de-icing chamber in a position designed such that the pressurized air ejection nozzle forms an air suction pump in the outlet pipe of the exchanger.

### CROSS-REFERENCE TO RELATED APPLICATIONS

This application is a continuation of International Application No. PCT/FR2014/050717, filed on Mar. 26, 2014, which claims the benefit of FR 13/52703, filed on Mar. 26, 2013. The disclosures of the above applications are incorporated herein by reference.

### FIELD

The present disclosure relates to a device for cooling the engine oil of a turbojet engine equipping an aircraft nacelle.

### BACKGROUND

The statements in this section merely provide background information related to the present disclosure and may not constitute prior art.

An aircraft is propelled by one or several propulsion unit(s) each comprising a turbojet engine housed in a tubular nacelle. Each propulsion unit is fastened to the aircraft by a mast generally located under or on a wing or at the fuselage.

It is meant by upstream what comes prior to the considered point or element, in the flow direction of the air in a turbojet engine, and it is meant by downstream what comes after the considered point or element, in the flow direction of the air in the turbojet engine.

A nacelle generally has a tubular front fairing forming an air inlet upstream of the turbojet engine, a median section intended for surrounding a fan or the compressors of the turbojet engine and its casing, a rear section able to accommodate thrust reversal means and intended for surrounding the gas generator of the turbojet engine.

The nacelle is generally terminated by an ejection nozzle outlet of which is located downstream of the turbojet engine.

Conventionally, the space comprised between the nacelle and the turbojet engine is called secondary channel.

The front fairing, or cowl, includes an aerodynamic outer wall, an inner wall for guiding air towards the turbojet engine, and a front lip forming a hollow leading edge which connects the inner wall and the outer wall and which delimits a defrosting annular chamber closed by a partition.

Generally, the turbojet engine comprises a set of vanes or blades (compressor and optionally fan or non-ducted propeller) driven in rotation by a gas generator through a set of transmission means.

A lubricant distribution system is provided to cool and provide a good lubrication of these transmission means and of any other accessory such as electric generators.

Consequently, the lubricant must also be cooled afterwards by a heat exchanger.

To this end, a first known method consists in cooling the lubricant by circulation through an air/oil heat exchanger using air taken from a secondary channel (flow called cold flow) of the nacelle or of one of the first compressor stages.

The extraction and circulation of air through this heat exchanger disrupts the flow of air and results in a loss of thrust of the engine, which is not advisable.

Moreover, the air extraction from the secondary channel generally requires an extension of the length of the median section of the nacelle.

It has been in particular calculated that in the case of a geared turbofan engine, this could represent losses equivalent to 1% of fuel consumption.

Another solution has appeared as part of the defrosting systems of the nacelle.

In fact, during flight, according to temperature and humidity conditions, ice may form on the nacelle, in particular at the outer surface of the air inlet lip equipping the front fairing of the nacelle.

The presence of ice or frost modifies the aerodynamic properties of the air inlet and disrupts the air channeling towards the fan. Moreover, the formation of frost on the air inlet of the nacelle and the ingestion of ice by the engine in the event ice blocks become detached may damage the engine or the airfoil and pose a risk for the safety of the flight.

It is known to maintain the outer surface of the lip at a sufficiently high temperature in order to prevent the appearance of frost.

Thus, the heat of the lubricant may be used to heat the outer surfaces of the lip, the lubricant thus being cooled and able to be reused in the lubricant circuit.

The document U.S. Pat. No. 4,782,658 describes the implementation of such a deicing system using the heat of the engine lubricant.

Specifically, the document U.S. Pat. No. 4,782,658 describes a defrosting system using the outdoor air taken by a scoop and heated through an air/oil heat exchanger to serve for the deicing.

Such a system allows for a better control of exchanged thermal energies.

But when the aircraft equipped with this type of system is stationary or moving at a low speed, the heat exchanger becomes ineffective due to the air flow rate through the heat exchanger, which is low or zero.

Furthermore, it is known the document U.S. Pat. No. 4,688,745 which describes and represents a deicing system which consists in creating a forced air flow in the defrosting annular chamber of the nacelle lip, to enhance thermal exchanges.

To this end, the system includes a pressurized air supply duct which extends from an inlet end connected on a pressurized hot air source, such as a high pressure compressor of the turbojet engine, to an outlet end forming an air ejection nozzle opening into the deicing chamber.

The ejection nozzle extends along a tangential direction to the annular chamber, so as to accelerate the air circulation in the chamber in order to enhance thermal exchanges between the moving air contained in the chamber and the outer lip delimiting the chamber.

Finally, the document FR-A-2788308 describes and represents a device for cooling a turbomachine speed reducer.

This device mainly includes a heat exchanger which has an inlet connected on an inlet duct which supplies the heat exchanger with cooling air and an outlet connected on an outlet duct which opens into the turbomachine nozzle to evacuate the air passing through the heat exchanger.

Complementarily, the device comprises a pressurized air supply duct which extends from an inlet end connected on a pressurized air source, such as a compressor, to an outlet end forming an air ejection nozzle opening into an air outlet duct of the heat exchanger.

Such a design allows accelerating the air circulation in the cooling device.

### SUMMARY

The present disclosure provides a cooling device of a turbojet engine of an aircraft nacelle to efficiently cool the engine oil when the aircraft is stationary or moving at a low speed, by limiting the number of valves and ducts of the device.

To this end, the present disclosure proposes a cooling device for a turbojet engine of an aircraft nacelle, including a heat exchanger which has an inlet connected on an inlet duct which supplies the heat exchanger with cooling air and an outlet connected on an outlet duct which evacuates the air passing through the heat exchanger, and the nacelle including a tubular front fairing which includes:

an aerodynamic outer wall,

an inner wall for guiding air towards the turbojet engine, and

a front lip forming a hollow leading edge which connects the inner wall and the outer wall and which delimits a deicing annular chamber closed by a partition.

characterized in that it includes a pressurized air supply duct which extends from an inlet end connected on a pressurized air source, to an outlet end forming an air ejection nozzle opening into the deicing chamber,

and in that the outlet duct of the heat exchanger has an air outlet segment which is arranged in the deicing chamber in a position adapted so that the pressurized air ejection nozzle forms an air suction pump in the outlet duct of the heat exchanger.

The device according to the present disclosure allows in particular to limit the number of valves and ducts by using the dual-mode pressurized air supply duct, while allowing an efficient operation of the heat exchanger with a low displacement speed of the aircraft.

According to another feature, the air outlet segment of the outlet duct of the heat exchanger is arranged outside the pressurized air ejection nozzle.

This arrangement enhances the suction of the air contained in the outlet duct of the heat exchanger, if necessary.

Moreover, the device includes a suction activation valve which is arranged on the air outlet duct of the heat exchanger and which is able to occupy at least one open state wherein the air can flow from the heat exchanger to the deicing chamber, and at least a closed state wherein the air flow is blocked.

Also, the device includes a non-return duct which extends from an inlet orifice branched on the air outlet duct of the heat exchanger, to an atmospheric air outlet opening, the non-return duct being equipped with a non-return shutter which is designed to allow the flow of the cooling air between the heat exchanger and the outside and only in that direction.

The unit composed of the non-return valve and shutter allows evacuating the cooling air when the suction activation valve is closed.

According to another feature, the device includes a discharge duct which extends from the deicing chamber to an atmospheric air outlet, and which is equipped with a discharge valve able to occupy an open state wherein the air can flow from said chamber to the outside of the nacelle, and a closed state wherein the flow of air is blocked.

The discharge duct allows regulating the pressure in the deicing chamber, in particular by decreasing the pressure in the chamber so as to enhance air suction in the cooling air outlet duct of the heat exchanger.

Furthermore, the air inlet duct of the heat exchanger includes an air inlet opening forming a scoop which is arranged on the outer wall of the fairing.

This feature allows supplying the heat exchanger with cooling air when the aircraft is in flight.

Also, the pressurized air supply duct is equipped with a regulation valve able to occupy an open state wherein the air may flow from the pressurized air source, to the deicing chamber, and a closed state wherein the flow of air is blocked, as well as any intermediate state allowing the variation of the collected air flow rate.

The regulation valve allows in particular regulating the temperature in the deicing chamber, and regulating the air suction in the outlet duct of the heat exchanger when in on-ground configuration.

Moreover, the pressurized air source is a high pressure compressor which equips the nacelle turbojet engine.

According to another aspect, the deicing chamber has a throttling in its inner section which is adapted to make the air passing through the throttling accelerate, and in that the throttling generally arranged around the air outlet segment of the outlet duct of the heat exchanger in order to create a Venturi effect and enhance the air flow in said duct.

Finally, the present disclosure also relates to a nacelle of a turbojet engine equipped with a cooling device according to any one the preceding claims.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic longitudinal sectional view, which illustrates a cooling device arranged in a front fairing of a nacelle within a configuration called cruise configuration, according to the present disclosure;

FIG. 2 is a schematic longitudinal sectional view similar to that of FIG. 1, which illustrates the device of FIG. 1 within a configuration called on-ground configuration;

FIG. 3 is a schematic longitudinal sectional view similar to that of FIG. 1, which illustrates the device of FIG. 1 within a configuration called deicing configuration;

FIG. 4 is a schematic cross-sectional partial view, which illustrates the arrangement of the cooling air outlet segment and of the pressurized air ejection nozzle, in the deicing chamber; and

FIG. 5 is a schematic cross-sectional partial view similar to that of FIG. 4, which illustrates the arrangement of the cooling air outlet segment and of the pressurized air ejection nozzle, in the deicing chamber, according to a variant.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

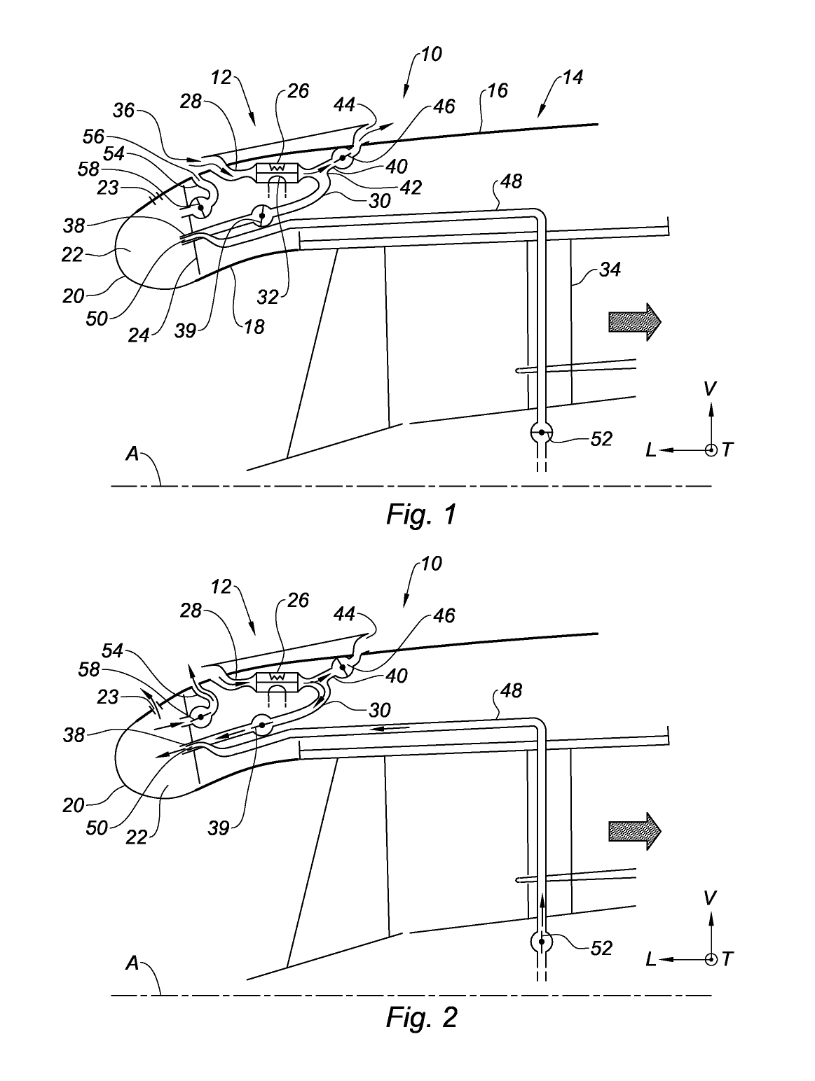

In the description and claims, the expressions “front” and “back” will be used in a non limiting manner with reference to the left portion and the right portion of the nacelle of FIGS. 1 to 3 respectively.

It should also be noted that in the present application, the terms “upstream” and “downstream” should be understood with respect to the air flow circulation inside the propulsion unit formed by the nacelle and the turbojet engine, that is to say from left to right according to FIGS. 1 to 3.

Moreover, in order to clarify the description and claims, the terminology longitudinal, vertical and transverse will be adopted in a non limiting manner with reference to the trihedral L, V, T indicated in the Figures, the axis of which L is parallel to axis A of the nacelle.

There is shown on FIG. 1 a front portion of a nacelle 10 (partially shown) equipped with a device 12 for cooling a turbojet engine lubricant (not shown) mounted in the nacelle 10.

The nacelle 10 has a tubular front fairing 14 or cowl, which is partially shown in FIG. 1 and which extends from front to back along a longitudinal central axis A.

The fairing 14 of the nacelle 10 includes an aerodynamic outer wall 16, an inner wall 18 forming an air circulation channel for guiding the air towards the turbojet engine, and a front lip 20 forming a hollow leading edge.

The lip 20 forms a rounded bead which connects the inner wall 18 and the outer wall 16 at the front of the nacelle 20, and which delimits a deicing annular chamber 22 closed by a partition 24.

The chamber 22 is equipped with an atmospheric outlet orifice 23 which opens outside the nacelle 10.

The cooling device 12 includes a heat exchanger 26 which has an inlet connected on an inlet duct 28 which supplies the heat exchanger 26 with cooling air and an outlet connected on an outlet duct 30 which evacuates the air passing through the heat exchanger 26.

The heat exchanger 26 is here of air/oil type, and is supplied, on the one hand, with the lubricant of the turbojet engine to be cooled, here with oil, and on the other hand, with air to be heated.

The oil is brought to the heat exchanger 26 by a pumping system of the turbojet engine (not shown) and a circulation duct 32 (partially shown) passing through a support arm 34 of the turbojet engine and passing through the air circulation channel.

The inlet duct 28 includes an air inlet opening 36 forming a scoop which is arranged on the outer wall 16 of the fairing 14 and which is designed to allow the flow of the cooling air from the outside of the nacelle 10, to the heat exchanger 26.

The outlet duct 30 of the heat exchanger 26 has an air outlet segment 38 which is arranged in the deicing chamber 22, the outlet duct 30 allowing to convey the lubricant heat dissipated by the heat exchanger 26 in the chamber 22.

With reference to FIG. 4, the air outlet segment 38 forms a 90-degree elbow which extends generally tangentially to the annular chamber 22, along axis B.

In a complementary manner, the outlet duct 30 of the heat exchanger 26 is equipped with an activation valve 39 which is able to occupy at least an open state wherein the air can flow from the heat exchanger 26 to the deicing chamber 22, and at least one closed state wherein the flow of air is blocked.

Moreover, the cooling device 12 includes a non-return duct 40 which extends from an inlet orifice 42 branched on the outlet duct 30 of the heat exchanger 26 to an atmospheric air outlet opening 44 arranged in the outer wall 16 of the fairing 14.

The non-return duct 40 is equipped with a non-return shutter 46 which is movably mounted between a closed state wherein it blocks the passage of air and an open state wherein the cooling air flows between the heat exchanger 26 and the outside of the nacelle 10.

According to another aspect, the cooling device 12 is equipped with a pressurized air supply duct, called thereafter high pressure duct 48.

The high pressure duct 48 extends from an inlet end (not shown) connected on a compressor (not shown) of the turbojet engine, forming a pressurized air source, to an outlet end forming an air ejection nozzle 50 opening into the deicing chamber 22.

Similarly, the high pressure duct 48 is equipped with a regulation valve 52 able to occupy an open state wherein the air may flow from the pressurized air source to the deicing chamber 22, and a closed state wherein the flow of air is blocked.

As it is shown in detail in FIG. 4, the air outlet segment 38 of the air outlet duct 30 of the heat exchanger 26 is arranged in the deicing chamber 22 in a position adapted so that the pressurized air ejection nozzle 50 forms an air suction pump in the outlet duct 30 of the heat exchanger 26.

More particularly, the air outlet segment 38 of the outlet duct 30 of the heat exchanger 26 is arranged inside the pressurized air ejection nozzle 50, coaxially to the air ejection nozzle 50, along axis B.

Such an arrangement allows forming a depression in the air outlet segment 38 of the outlet duct 30 of the heat exchanger 26 by accelerating the flow of air by means of the pressurized air ejection nozzle 50.

Advantageously, this feature provides an effective operation of the heat exchanger 26 by allowing the cooling air to pass through the heat exchanger 26, by suction through the associated outlet duct 30, even when the aircraft has a low or zero speed.

Moreover, the cooling device 12 includes a discharge duct 54 which extends from the deicing chamber 22 to an atmospheric air outlet 56 arranged in the outer wall 16 of the fairing 14.

The discharge duct 54 is equipped with a discharge valve 58 able to occupy an open state wherein the air can flow from the chamber 22 to the outside the nacelle 10, and a closed state wherein the flow of air is blocked.

According to one form as shown in FIG. 5, the deicing chamber 22 has a throttling 60 in its inner section which is generally arranged around the air outlet segment 38 of the air outlet duct 30 of the heat exchanger 26.

According to this form, the throttling creates a Venturi effect by acceleration of the air which flows in the chamber 22 and enhances the flow of air in the air outlet duct 30 by suction.

The cooling device 12 according to the present disclosure is designed to operate according to different configurations, described below by way of non limiting examples of operation.

In a configuration called cruise configuration shown in FIG. 1, wherein the aircraft is supposed to be in flight, the discharge valve 58, the activation valve 39 and the regulation valve 52 are closed, only the non-return shutter 46 is open.

Thus, in the cruise configuration, the fresh outside air flows successively towards the inlet duct 28 of the heat exchanger 26, the heat exchanger 26, the outlet duct 30 of the heat exchanger 26, the non-return duct 40 and the air outlet opening 44.

The flow of air here allows efficiently cooling the lubricant by means of the heat exchanger 26.

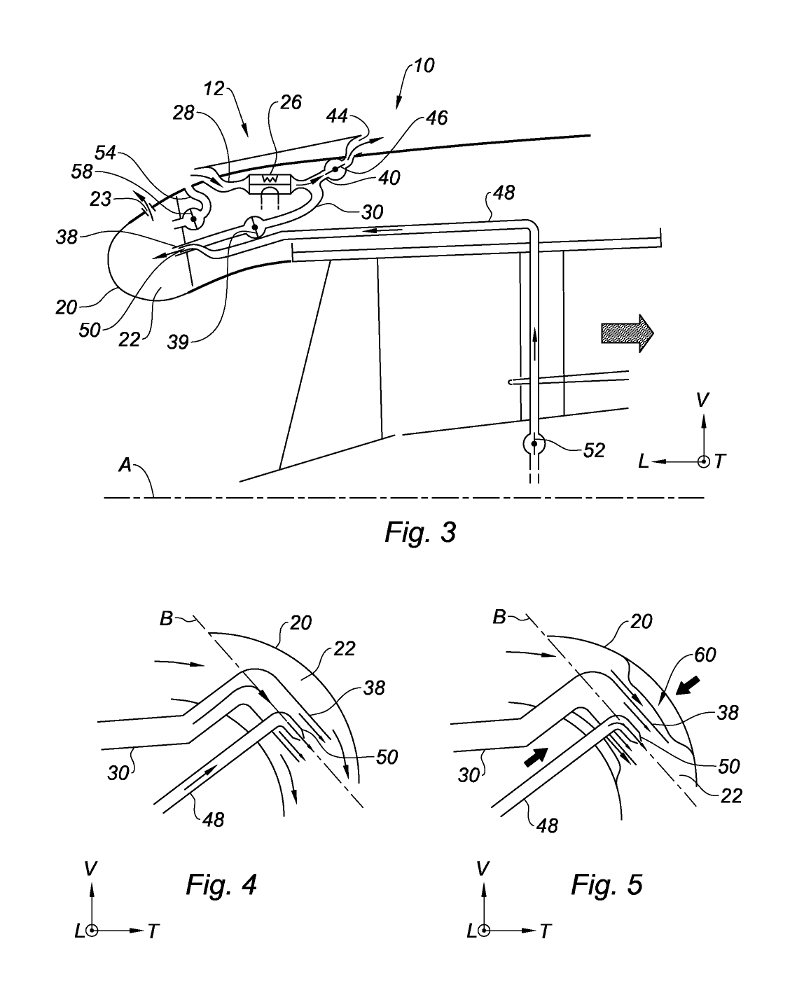

In a configuration called deicing configuration shown in FIG. 3, wherein the aircraft is supposed to be in flight, the discharge valve 58 and the activation valve 39 are closed, and the non-return shutter 46 and the regulation valve 52 are open.

According to this deicing configuration, the fresh outside air flows through the heat exchanger 26 by being evacuated by the non-return duct 40, such as in the cruise mode.

Moreover, the hot air coming from the compressor is injected in the deicing chamber 22 by the high pressure duct 48, in order to enhance the deicing of the lip 20 of the nacelle 10.

The pressurized air injected by the high pressure duct 48 escapes from the chamber 22 through the outlet orifice 23 provided for this purpose.

Finally, in a mode called on-ground mode shown in FIG. 2, wherein the aircraft is assumed to be on the ground moving at low or zero speed, the discharge valve 58, the regulation valve 52 and the activation valve 39 are open, and the non-return shutter 46 is closed.

According to this on-ground configuration, the pressurized air coming from the compressor is injected in the defrosting chamber 22 by the high pressure duct 48, so that the pressurized air ejection nozzle 50 forms a pump for suctioning the air in the outlet duct 30 of the heat exchanger 26.

Thus, in the on-ground configuration, fresh air passes through the heat exchanger 26 even when the aircraft moves at a low or zero speed.

Still in on-ground configuration, the discharge valve 58 is open to decrease the pressure in the chamber 22, in order to avoid a hot air return from the chamber 22, to the heat exchanger 26 via the outlet duct 30 of the heat exchanger 26.

The driving of the aforementioned valves 39, 52, 58 and shutter 40 is performed by a driving and controlling device which is not shown. The shutter may, alternatively, operate in a passive manner by pressure difference, and thus prevent the air from flowing in the outlet opening 40 direction towards the outlet duct 30.

It may be noted that several valves may be driven by a same control member.

In fact, the discharge valve 58 and the suction activation valve 39 are open at the same time, whereas the non-return shutter 40 is simultaneously closed, and vice versa.

Finally, in the event of failure of one of the valves of the unit, it is possible to make the aircraft available, that is to say, to allow it to fly, with the regulation valve 52 forced open, the regulation of the temperature in the deicing chamber 22 may be carried out by the discharge valve 58.

Advantageously, the present disclosure proposes a cooling device 12 which allows deicing the lip 20 of the nacelle 10 and efficiently cooling the lubricant of the turbojet engine even in an on-ground configuration at a low or zero speed, by limiting the number of valves and ducts required for the circulation of air.

In fact, here the high pressure duct 48 provides a dual function, namely a function of deicing by pressurized hot air injection in the deicing chamber 22 of the lip 20, and a function of suctioning air in the outlet duct 30 of the heat exchanger 26. This feature allows in particular a mass gain, of reliability and maintenance of the device 12 according to the present disclosure, as well as a consumption gain with respect to a cooling device which draws the cooling air from the secondary channel.

What is claimed is:

1. A cooling device for a turbojet engine of an aircraft nacelle, comprising:
a heat exchanger which has an inlet connected on an inlet duct which supplies the heat exchanger with an cooling air; and
an outlet connected on an outlet duct which evacuates the air passing through the heat exchanger, the nacelle including a front fairing which comprises:
an aerodynamic outer wall;
an inner wall configured to guide an air towards the turbojet engine; and
a front lip forming a hollow leading edge which connects the inner wall and the aerodynamic outer wall and which delimits a deicing annular chamber closed by a partition.
wherein the cooling device further comprises a pressurized air supply duct which extends from an inlet end connected on a pressurized air source, to an outlet end forming an air ejection nozzle opening into the deicing annular chamber,
wherein the outlet duct of the heat exchanger has an air outlet segment which is arranged in the deicing annular chamber in a position adapted so that the air ejection nozzle forms an air suction pump in the outlet duct of the heat exchanger, and
wherein the cooling device includes a discharge duct which extends from the deicing annular chamber to an atmospheric air outlet, and which is equipped with a discharge valve configured to occupy an open state where the air flows from the deicing annular chamber to an outside of the nacelle, and a closed state where a flow of the air is blocked.

2. The cooling device according to claim 1, wherein the air outlet segment of the outlet duct of the heat exchanger is arranged outside the air ejection nozzle.

3. The cooling device according to claim 1, wherein the cooling device comprises a suction activation valve which is arranged on the air outlet duct of the heat exchanger and which is configured to occupy at least one open state in which the air can flow from the heat exchanger to the deicing annular chamber, and at least one closed state in which the flow of air is blocked.

4. The cooling device according to claim 1, wherein the cooling device comprises a non-return duct which extends from an inlet orifice branched on the air outlet duct of the heat exchanger, to an atmospheric air outlet opening, the non-return duct being equipped with a non-return shutter which is configured to allow the flow of the cooling air between the heat exchanger and an outside thereof only in a direction of the flow of the cooling air.

5. The cooling device according to claim 1, wherein the inlet duct of the heat exchanger comprises an air inlet opening forming a scoop which is arranged on the aerodynamic outer wall of the front fairing.

6. The cooling device according to claim 1, wherein the pressurized air supply duct is equipped with a regulation valve configured to occupy an open state where the air may flow from the pressurized air source, to the deicing annular chamber, and a closed state where the flow of air is blocked.

7. The cooling device according to claim 1, wherein the pressurized air source is a high pressure compressor which equips the turbojet engine of the nacelle.

8. The cooling device according to claim 1, wherein the deicing annular chamber comprises a throttling in an inner section thereof which is adapted for accelerating the air which passes through the throttling, and wherein the throttling is arranged generally around the air outlet segment of the outlet duct of the heat exchanger, creating a Venturi effect and enhancing the flow of air in the outlet duct.

9. The cooling device according to claim 1, wherein the deicing annular chamber is equipped with an atmospheric outlet orifice which opens outside the nacelle.

10. A nacelle for a turbojet engine equipped with the cooling device according to claim 1.
